(19) United States
(12) Patent Application Publication
(10) Pub. No.: US 2026/0133789 A1
(43) Pub. Date: May 14, 2026

(54) UPDATING METHOD, RECOVERY METHOD AND BACKUP METHOD FOR FIRMWARE OF BATTERY

(71) Applicant: Acer Incorporated, New Taipei City (TW)

(72) Inventor: Pe-Yi LIN, New Taipei City (TW)

(73) Assignee: Acer Incorporated, New Taipei City (TW)

(21) Appl. No.: 19/288,501

(22) Filed: Aug. 1, 2025

(30) Foreign Application Priority Data
Nov. 14, 2024 (TW) 113143839

(51) Int. Cl. G06F 8/65

(52) U.S. Cl. CPC G06F 8/65

(57) ABSTRACT

An updating method, a recovery method and a backup method for a firmware of a battery are provided. The updating method for the firmware of the battery includes the following steps. Whether an electronic device has received an update command is determined. If the electronic device receives the update command, whether the firmware backup data is stored in a EFI System Partition (ESP) of a hard disk is determined. If the firmware backup data is stored in the hard disk, whether the update command contains a L1 seal key or a L2 seal key is determined. If the update command contains the L1 seal key, a first-level data of the firmware is updated. If the update command contains the L2 seal key, the first-level data and a second-level data of the firmware are updated.

This application claims the benefit of Taiwan application Serial No. 113143839, filed Nov. 14, 2024, the disclosure of which is incorporated by reference herein in its entirety.

### TECHNICAL FIELD

The disclosure relates in general to a processing method for a battery, and more particularly to an updating method, a recovery method and a backup method for a firmware of a battery.

### BACKGROUND

With the rapid growth of the current electronic device market, the requirements for the batteries that they are equipped with are also getting higher and higher. When necessary, the battery firmware will be updated to extend the battery life or delay battery aging. However, when the battery memory is damaged or the capacity is not large enough, the battery cannot be updated.

Therefore, the industry is currently working hard to develop new ways to update battery firmware to ensure that the battery could be updated and used normally.

### SUMMARY

This disclosure is directed to an updating method, a recovery method and a backup method for a firmware of a battery, which back up the battery firmware in a hard disk, so that the battery firmware could be updated safely and ensure the battery could operate normally and stably in the future.

According to one embodiment, an updating method for a firmware of a battery is provided. The updating method for the firmware of the battery includes the following steps. Whether an electronic device has received an update command is determined. Whether a firmware backup data is stored in a EFI System Partition (ESP) of a hard disk is determined, if the electronic device receives the update command. Whether the update command contains a L1 seal key or a L2 seal key is determined, if the firmware backup data is stored in the hard disk. A first-level data of the firmware is updated, if the update command contains the L1 seal key. The first-level data and a second-level data of the firmware are updated, if the update command contains the L2 seal key.

According to another embodiment, a recovery method for a firmware of a battery is provided. The recovery method for the firmware of the battery includes the following steps. Whether an electronic device meets a recovery condition is determined. Whether a firmware backup data exists in an EFI System Partition (ESP) of a hard disk is determined, if the electronic device meets the recovery condition. The firmware backup data is read from the EFI System Partition (ESP), if the firmware backup data exists in the hard disk. The firmware of the battery is restored to write the firmware backup data to the battery.

According to an alternative embodiment, a backup method for a firmware of a battery is provided. The backup method for the firmware of the battery includes the following steps. Whether an electronic device meets a backup condition is determined. The firmware of the battery is backed up to write a firmware backup data to an EFI System Partition (ESP) of a hard disk, if the electronic device meets the backup condition.

### BRIEF DESCRIPTION OF THE DRAWINGS

FIG. 1 illustrates a block diagram of an electronic device according to an embodiment of the present disclosure.

FIG. 2 is a schematic diagram of an updating method for the firmware of the battery according to an embodiment of the present disclosure.

FIG. 3 is a flow chart of an updating method for the firmware of the battery according to an embodiment of the present disclosure.

FIG. 4 is a schematic diagram of restoring the firmware of the battery according to an embodiment of the present disclosure.

FIG. 5 is a flowchart of a recovery method for the firmware of the battery according to an embodiment of the present disclosure.

FIG. 6 illustrates a schematic diagram of backing up the firmware of the battery according to an embodiment of the present disclosure.

FIG. 7 illustrates a flowchart of a backup method for the firmware of the battery according to an embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

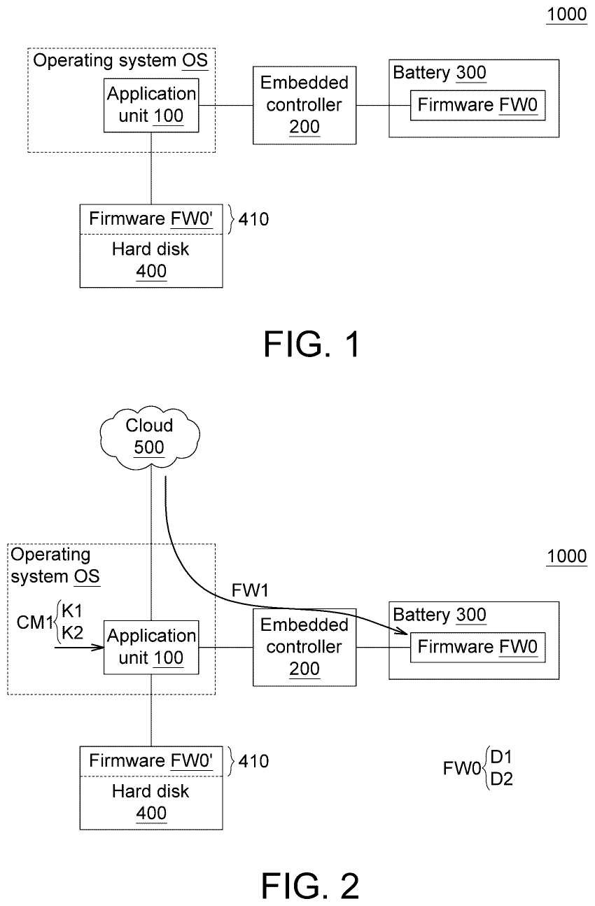

Please refer to FIG. 1, which illustrates a block diagram of an electronic device 1000 according to an embodiment of the present disclosure. The electronic device 1000 includes an application unit 100 of an operating system unit OS, an embedded controller 200, a battery 300, and a hard disk 400.

The embedded controller 200 could be declared as an I2C Human interface device (I2C HID), so that the embedded controller 200 could directly communicate with the application unit 100 of the operating system unit OS to perform firmware update, backup or recovery operations. The application unit 100 is used for data access, analysis and judgment procedures, such as a circuit, a circuit board, a storage device storing program code or a chip. The chip is, for example, a central processing unit (CPU), a programmable general-purpose or special-purpose micro control unit (MCU), a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), an embedded system, a field programmable gate array (FPGA), other similar element or a combination thereof.

In this embodiment, by storing a firmware backup data FW0′ in an EFI System Partition (ESP) 410 of the hard disk 400, when the firmware FW0 in the battery 300 needs to be updated, the security of the update can be ensured. The following is a flowchart to explain in detail the operation of each component.

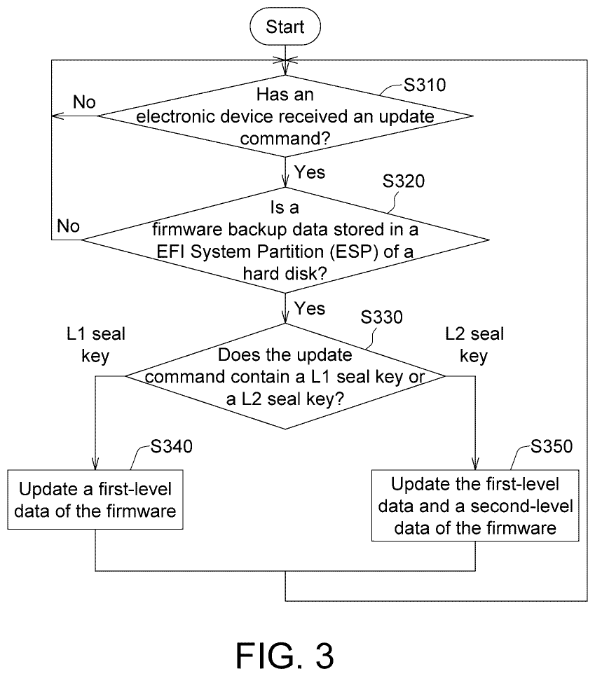

Please refer to FIG. 2 and FIG. 3 at the same time. FIG. 2 is a schematic diagram of an updating method for the firmware of the battery 300 according to an embodiment of the present disclosure. FIG. 3 is a flow chart of an updating method for the firmware of the battery 300 according to an embodiment of the present disclosure. The updating method for the firmware of the battery 300 includes step S310 to step S350.

In the step S310, as shown in FIG. 2, the application unit 100 determines whether the electronic device 1000 receives an update command CM1. The update command CM1 is used to download a firmware FW1 from the cloud 500 and update a firmware FW0 in the battery 300. If the electronic device 1000 receives the update command CM1, the process proceeds to the step S320.

In the step S320, as shown in FIG. 2, the application unit 100 determines whether the firmware backup data FW0′ exists in the EFI System Partition (ESP) 410 of the hard disk 400. The EFI System Partition (ESP) 410 is, for example, 250 MB, for storing the firmware backup data FW0′. In this embodiment, the firmware backup data FW0′ is stored in the EFI System Partition (ESP) 410 of the hard disk 400, and there is no need to prepare a large-capacity memory inside the battery 300. In the case of insufficient memory capacity, there is no need to replace the memory or replace the battery 300, and the firmware backup data FW0′ could be successfully stored.

If the EFI System Partition (ESP) 410 of the hard disk 400 has stored the firmware backup data FW0′, then the process enters the step S330.

In the step S330, as shown in FIG. 2, the application unit 100 determines whether the update command CM1 contains an L1 seal key K1 or an L2 seal key K2. The L1 seal key K1 and the L2 seal key K2 are used to limit the update of different levels of firmware FW0 data to improve data security. The L1 seal key K1 is used to update the basic data of the firmware FW0, and the L2 seal key K2 is used to update the advanced data of the firmware FW0. When the primary data is updated incorrectly, it will not affect the normal operation of the battery 300, but when the advanced data is updated incorrectly, it may cause the battery 300 to be unable to operate.

If the update command CM1 contains the L1 seal key K1, the process proceeds to the step S340; if update command CM1 contains the L2 seal key K2, the process proceeds to the step S350.

In the step S340, as shown in FIG. 2, the application unit 100 downloads the firmware FW1 from the cloud 500 and updates a first-level data D1 of the firmware FW0 of the battery 300.

When updating the first-level data D1 of the firmware FW0 of the battery 300, the embedded controller 200 is declared as an I2C human interface device (I2C HID), so that the embedded controller 200 could directly communicate with the application unit 100 of the operating system unit OS for updating.

In the step S350, as shown in FIG. 2, the application unit 100 downloads the firmware FW1 from the cloud 500, and updates the first-level data D1 and the second-level data D2 of firmware FW0 of the battery 300 (or only the first-level data D1 or the second-level data D2 of the firmware FW0 may be updated).

When the application unit 100 updates the second-level data D2 of the firmware FW0 of the battery 300, the embedded controller 200 is declared as an I2C human interface device (I2C HID), so that the embedded controller 200 can directly communicate with the application unit 100 of the operating system unit OS for updating.

When an error occurs during the update or when the firmware FW1 of the battery 300 is abnormal, it is necessary to restore the firmware FW1 of the battery 300. The following is a block diagram and flow chart to further explain.

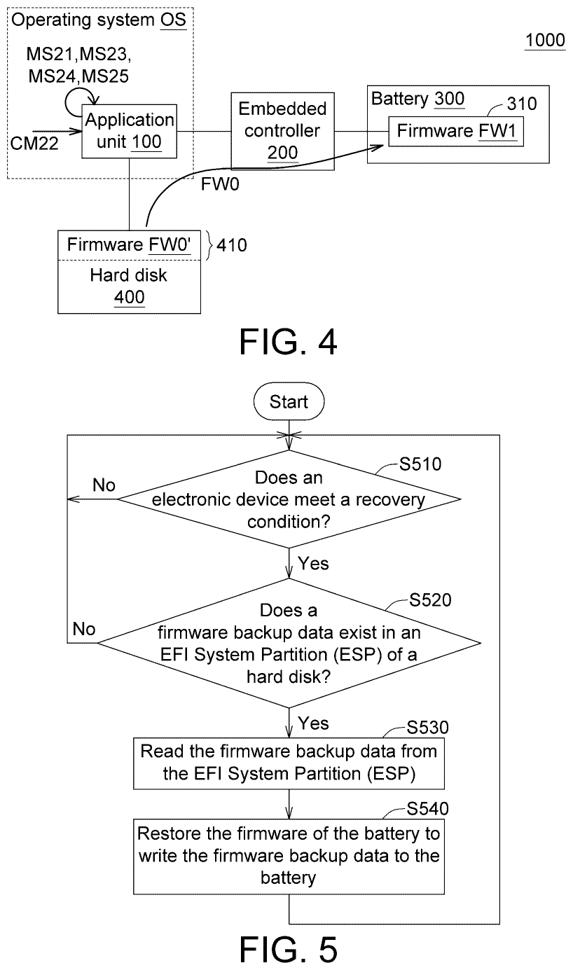

Please refer to FIG. 4 and FIG. 5 at the same time. FIG. 4 is a schematic diagram of restoring the firmware of the battery 300 according to an embodiment of the present disclosure. FIG. 5 is a flowchart of a recovery method for the firmware of the battery according to an embodiment of the present disclosure.

In this embodiment, the recovery method for the firmware FW1 of the battery 300 includes steps S510 to S540. In the step S510, the application unit 100 determines whether the electronic device 1000 meets a restoration condition. The restoration condition is, for example, that the application unit 100 receives an update failed message MS21, a user recovery command CM22, a power error message MS23, a verification code error message MS24, or a safety mechanism failure message MS25. If the electronic device 1000 meets the restoration condition, the process proceeds to the step S520.

The user recovery command CM22 is a recovery command initiated manually by the user, for example, when the update fails or the new firmware FW1 does not work well, the user wishes to restore to the original firmware FW0.

In the step S520, the application unit 100 determines whether the firmware backup data FW0′ exists in the EFI System Partition (ESP) 410 of the hard disk 400. If the firmware backup data FW0′ already exists in the EFI System Partition (ESP) 410 of the hard disk 400, the process proceeds to the next step S530.

In the step S530, the application unit 100 reads the firmware backup data FW0′ from the EFI System Partition (ESP) 410.

Next, in the step S540, the firmware FW1 of the battery 300 is restored to write the firmware backup data FW0′ to the battery 300.

When the firmware FW1 of the battery 300 is restored, the embedded controller 200 is declared as an I2C human interface device (I2C HID), so that the embedded controller 200 could directly communicate with the application unit 100 of the operating system unit OS to perform the restoration.

When the firmware FW0 of battery 300 has been updated to the new firmware FW1 or the firmware FW1 has not been backed up, the firmware FW1 of battery 300 needs to be backed up. The following is a block diagram and flow chart to further explain.

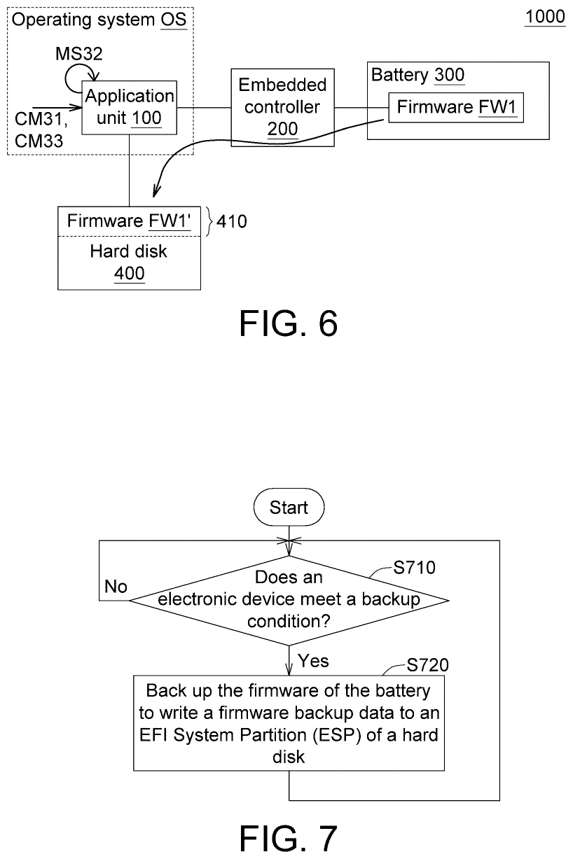

Please refer to FIG. 6 and FIG. 7 at the same time. FIG. 6 illustrates a schematic diagram of backing up the firmware of the battery according to an embodiment of the present disclosure. FIG. 7 illustrates a flowchart of a backup method for the firmware of the battery according to an embodiment of the present disclosure.

The backup method for the firmware FW1 of the battery 300 includes steps S710 to S720. In the step S710, the application unit 100 determines whether the electronic device 1000 meets a backup condition. The backup condition is, for example, that an update executing command CM31, an update completion message MS32, or a user backup command CM33 is received. If the electronic device 1000 meets the backup condition, the proceeds to the step S720.

The user backup command CM33 is a backup action manually initiated by the user, for example, when the hard disk 400 is replaced or the backup is lost, the user wishes to back up firmware FW1.

In the step S720, the application unit 100 backs up the firmware FW1 of the battery 300 to write the firmware backup data FW1′ to the EFI System Partition (ESP) 410 of the hard disk 400.

In this embodiment, the firmware backup data FW0′, FW1′ is stored in the hard disk 400, so that the memory space of the battery 300 is not occupied. In addition, when the battery 300 performs a firmware update, the security of the update could be ensured.

Furthermore, is the above embodiment, two layers of keys, the L1 seal key K1 and the L2 seal key K2, are used to improve the security of the firmware.

In addition, when updating, restoring or backing up, the embedded controller 200 is declared as an I2C human interface device (I2C HID), so that the embedded controller 200 can communicate directly with the application unit 100 of the operating system unit OS without using Windows Management Instrumentation (WMI) to complete the communication between the two, and there will be no system management interrupt (SMI) and thus many operational problems.

The above disclosure provides various features for implementing some implementations or examples of the present disclosure. Specific examples of components and configurations (such as numerical values or names mentioned) are described above to simplify/illustrate some implementations of the present disclosure. Additionally, some embodiments of the present disclosure may repeat reference symbols and/or letters in various instances. This repetition is for simplicity and clarity and does not inherently indicate a relationship between the various embodiments and/or configurations discussed.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. An updating method for a firmware of a battery, comprising:
determining whether an electronic device has received an update command;
determining whether a firmware backup data is stored in a EFI System Partition (ESP) of a hard disk, if the electronic device receives the update command;
determining whether the update command contains a L1 seal key or a L2 seal key, if the firmware backup data is stored in the hard disk;
updating a first-level data of the firmware, if the update command contains the L1 seal key; and
updating the first-level data and a second-level data of the firmware, if the update command contains the L2 seal key.

2. The updating method for the firmware of the battery according to claim 1, wherein the EFI System Partition (ESP) is 250 MB.

3. The updating method for the firmware of the battery according to claim 1, wherein when updating the first-level data of the firmware of the battery, an embedded controller is declared as an I2C Human interface device (I2C HID) so that the embedded controller communicates directly with an application unit of an operating system unit for updating.

4. The updating method for the firmware of the battery according to claim 1, wherein when updating the second-level data of the firmware of the battery, an embedded controller is declared as an I2C Human interface device (I2C HID), so that the embedded controller directly communicates with an application unit of an operating system unit to perform the update.

5. The updating method for the firmware of the battery according to claim 1, wherein the L1 seal key is used to update a basic data of the firmware, and the L2 seal key is used to update an advanced data of the firmware.

6. A recovery method for a firmware of a battery, comprising:
determining whether an electronic device meets a recovery condition;
determining whether a firmware backup data exists in an EFI System Partition (ESP) of a hard disk, if the electronic device meets the recovery condition;
reading the firmware backup data from the EFI System Partition (ESP), if the firmware backup data exists in the hard disk; and
restoring the firmware of the battery to write the firmware backup data to the battery.

7. The recovery method for the firmware of the battery according to claim 6, wherein the recovery condition is that an update failed message is received.

8. The recovery method for the firmware of the battery according to claim 6, wherein the recovery condition is that a user recovery command is received.

9. The recovery method for the firmware of the battery according to claim 6, wherein the recovery condition is that a power error message is received.

10. The recovery method for the firmware of the battery according to claim 6, wherein the recovery condition is that a verification code error message is received.

11. The recovery method for the firmware of the battery according to claim 6, wherein the recovery condition is that a safety mechanism failure message is received.

12. The recovery method for the firmware of the battery according to claim 6, wherein when restoring the firmware of the battery, an embedded controller is declared as an I2C human interface device (I2C HID), so that the embedded controller communicates directly with an application unit of an operating system unit for updating.

13. The recovery method for the firmware of the battery according to claim 6, wherein the EFI System Partition (ESP) is 250 MB.

14. A backup method for a firmware of a battery, comprising:
determining whether an electronic device meets a backup condition; and
backing up the firmware of the battery to write a firmware backup data to an EFI System Partition (ESP) of a hard disk, if the electronic device meets the backup condition.

15. The backup method for the firmware of the battery according to claim 14, wherein the backup condition is that an update executing command is received and the firmware backup data does not exist in the EFI System Partition (ESP).

16. The backup method for the firmware of the battery according to claim 14, wherein the backup condition is that an update executing command is received.

17. The backup method for the firmware of the battery according to claim 14, wherein the backup condition is that an update completion message is received.

18. The backup method for the firmware of the battery according to claim 14, wherein the backup condition is that a user backup command is received.

19. The backup method for the firmware of the battery according to claim 14, wherein the EFI System Partition (ESP) is 250 MB.

20. The backup method for the firmware of the battery according to claim 14, wherein when backing up the firmware of the battery, an embedded controller is declared as an I2C human interface device (I2C HID), so that the embedded controller communicates directly with an application unit of an operating system unit for updating.
